(19) United States
(12) Patent Application Publication
(10) Pub. No.: US 2016/0293134 A1
(43) Pub. Date: Oct. 6, 2016

(54) RENDERING SYSTEM, CONTROL METHOD AND STORAGE MEDIUM

(71) Applicant: SQUARE ENIX HOLDINGS CO., LTD., Shinjuku-ku, Tokyo (JP)

(72) Inventor: Jean-François F FORTIN, Montreal (CA)

(73) Assignee: SQUARE ENIX HOLDINGS CO., LTD., Shinjuku-ku (JP)

(21) Appl. No.: 15/033,155

(22) PCT Filed: Jul. 25, 2014
(86) PCT No.: PCT/JP2014/070290

§ 371 Date: Apr. 29, 2016

Related U.S. Application Data
(60) Provisional application No. 61/920,835, filed on Dec. 26, 2013.

(51) Int. Cl. G09G 5/00; A63F 13/355

(52) U.S. Cl. CPC G09G 5/006; A63F 13/355; G09G 2370/022

(57) ABSTRACT

In a rendering system comprising a central server which causes one of rendering servers to execute rendering processing for a screen, and a repository device which stores resource data for the rendering processing and which the rendering servers are able to access, the central server transmits resource data to the repository device based on a request sent from a client device, and generates rendering commands including identification information identifying the resource data stored in the repository device and transmits the commands to one of the rendering servers. The repository device stores the resource data in association with the identification information, and the rendering server receives rendering commands, receives the resource data identified by the identification information included in the received rendering commands from the repository device and loads the data into a memory, and renders a screen using the loaded resource data.

### TECHNICAL FIELD

The present invention relates generally to a rendering system, a control method of the rendering system and a storage medium.

### BACKGROUND ART

In recent years, cloud gaming systems have come to be proposed. According to the cloud gaming systems, even though an electronic device (client) does not have sufficient rendering capabilities, the user can experience any games by using the device. In a cloud gaming system, processing for a game is performed on a server, and client devices, such as electronic devices, by transmitting operation input for the game via a network to the server, can receive, as video data in a streaming format, from the server, game screens in which the operation input is reflected. Regarding cloud gaming systems, generation of game screens corresponding to a plurality of client devices is performed in parallel, and so simultaneous calculation capabilities are required, and so a configuration can be considered in which, in order to perform load distribution, roles are separated between a server that performs basic calculation for the game (a CPU server), and a server that generates game screens by rendering processing with a GPU (a GPU server), which are physically separated. Multiple GPU servers may be configured to connect to the CPU server, and in such cases, the CPU server may assign to one of the GPU servers generation of the game screens to be provided to client devices in a connected state, and may transmit rendering commands to the GPU server.

Note, in cases where multiple GPU servers exist, storing of rendering object data (resource data) used for rendering processing in all of the GPU servers is not realistic when one considers the effort required to update the data in cases where the necessity to change the data arises, the cost introduced in order to provide each GPU server with storage that can store all of the resource data, and the like. Accordingly, the CPU server must transmit rendering commands and resource data used for rendering processing. In this regard, it is similar to Web games except that the client, which received the resource data, performs rendering processing. Also, in a case implementation of a cloud gaming system is made in which games for home-use video game consoles, PCs, mobile devices, etc. published in the past are executable, the source code for the game and all of the resource data is not received and compiled into an application that operates on the server, but rather a format in which disk image data or binary data of the game is executed in an emulation environment of the home-use video game console is employed. In such cases, by executing the game on the emulation environment, the necessary resource data can be acquired from the disk image data or the binary data as an emulation result of a loading operation on the game device.

In other words, in cases where games for PCs, home-use video game consoles, etc. that were published in the past are adopted for a cloud gaming system, because the resource data can be acquired only in the middle of the processing for the execution of the game on the CPU server, it is necessary to transmit the resource data when causing an external GPU server to render.

However, particularly in cases in which the system is configured such that a plurality of GPU servers are connected to one CPU server, because a situation in which resource data is transmitted in parallel to each of the plurality of GPU servers can arise, there is a possibility that a usage amount of communication bandwidth exceeds a physical limit amount at such a time. In such cases, delays in the transmission of the resource data to the GPU server occur, and as a result delays in the provision of game screens in the client device occur, and there is the possibility that the user's interest in the game is reduced, or that the game itself fails. On the other hand, in embodiments of cloud gaming systems, it is envisioned that systems will be configured so as to be able to provide predetermined types of games. In other words, the user using the client device can initiate the execution of a game on the CPU server by connecting his or her device to the server, and selecting the game that he or she wishes to play from games prepared beforehand. In this way, in the system, because there is the possibility that game screens for the same game will be provided to a plurality of client devices, there is the possibility that the same resource data will be used for rendering processing of game screens provided to different client devices.

### SUMMARY OF INVENTION

According to one aspect of the present invention, there is provided a rendering system comprising a central server which causes one of a plurality of rendering servers connected to the central server to execute rendering processing for a screen corresponding to a screen providing request sent from a client device, and a repository device which stores necessary resource data for the rendering processing and which the plurality of rendering servers are able to access, wherein the central server comprises: request receiving means for receiving the screen providing requests from client devices; resource transmitting means for transmitting, based on the screen providing request received by the request receiving means, necessary resource data for rendering processing corresponding to the screen providing request to the repository device; and command transmitting means for generating rendering commands which include identification information identifying the necessary resource data stored in the repository device and for transmitting the commands to one of the plurality of rendering servers, wherein the repository device comprises storage means for storing the necessary resource data transmitted by the resource transmitting means in association with the identification information, and wherein the rendering server comprises: command receiving means for receiving rendering commands from the central server; loading means for receiving, from the repository device, the necessary resource data identified by the identification information included in the received rendering commands and for loading the data into a memory; rendering means for executing, based on the received rendering commands, rendering processing using the necessary resource data loaded in the memory and rendering a screen corresponding to the screen providing request; and screen transmitting means for transmitting the rendered screen to a client device, which transmitted the screen providing request.

According to another aspect of the present invention, there is provided a control method of a rendering system comprising a central server which causes one of a plurality of rendering servers connected to the central server to execute rendering processing for a screen corresponding to a screen providing request sent from a client device, and a repository device which stores necessary resource data for the rendering processing and which the plurality of rendering servers are able to access, the method comprising the steps of: the central server receiving the screen providing requests from client devices; the central server transmitting, based on the received screen providing request, necessary resource data for rendering processing corresponding to the screen providing request to the repository device; the repository device storing the necessary resource data transmitted by the central server in association with identification information identifying the necessary resource data, the central server generating rendering commands which include the identification information and transmitting the commands to one of the plurality of rendering servers, the rendering server receiving rendering commands from the central server; the rendering server receiving, from the repository device, the necessary resource data identified by the identification information included in the received rendering commands and loading the data into a memory; the rendering server executing, based on the received rendering commands, rendering processing using the necessary resource data loaded in the memory and rendering a screen corresponding to the screen providing request; and the rendering server transmitting the rendered screen to a client device, which transmitted the screen providing request.

These and other aspects and features of the present invention will now become apparent to those of ordinary skill in the art upon review of the following description of specific embodiments of the invention in conjunction with the accompanying drawings.

### BRIEF DESCRIPTION OF DRAWINGS

In the accompanying drawings:

FIG. 1A is a block diagram of a cloud-based video game system architecture including a server system, according to a non-limiting embodiment of the present invention.

FIG. 1B is a block diagram of the cloud-based video game system architecture of FIG. 1A, showing interaction with the set of client devices over the data network during game play, according to a non-limiting embodiment of the present invention.

FIG. 2A is a block diagram showing various physical components of the architecture of FIGS. 1A and 1B, according to a non-limiting embodiment of the present invention.

FIG. 2B is a variant of FIG. 2A.

FIG. 2C is a block diagram showing various modules of the server system in the architecture of FIGS. 1A and 1B, which can be implemented by the physical components of FIG. 2A or 2B and which may be operational during game play.

FIGS. 3A to 3C are flowcharts showing execution of a set of video game processes carried out by a rendering command generator, in accordance with non-limiting embodiments of the present invention.

FIGS. 4A and 4B are flowcharts showing operation of a client device to process received video and audio, respectively, in accordance with non-limiting embodiments of the present invention.

FIG. 5 is a diagram showing an exemplary rendering system in accordance with one aspect of the present invention.

FIG. 6 is a sequence diagram of an exemplary process executed in a rendering system in accordance with one aspect of the present invention.

FIG. 7 is a diagram showing an exemplary rendering system in accordance with another aspect of the present invention.

FIG. 8 shows a client device in accordance with a non-limiting embodiment of the present invention.

It is to be expressly understood that the description and drawings are only for the purpose of illustration of certain embodiments of the invention and are an aid for understanding. They are not intended to be a definition of the limits of the invention.

### DESCRIPTION OF EMBODIMENTS

### I. Cloud-Based System Architecture

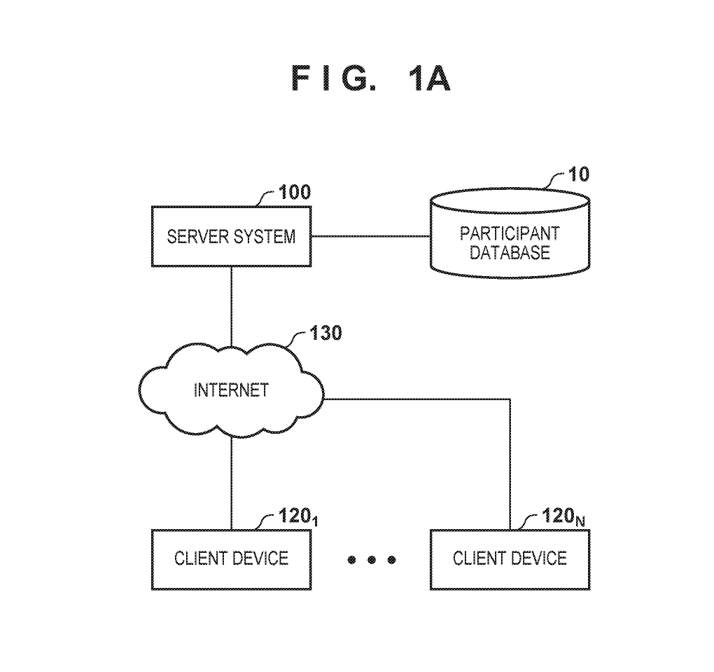

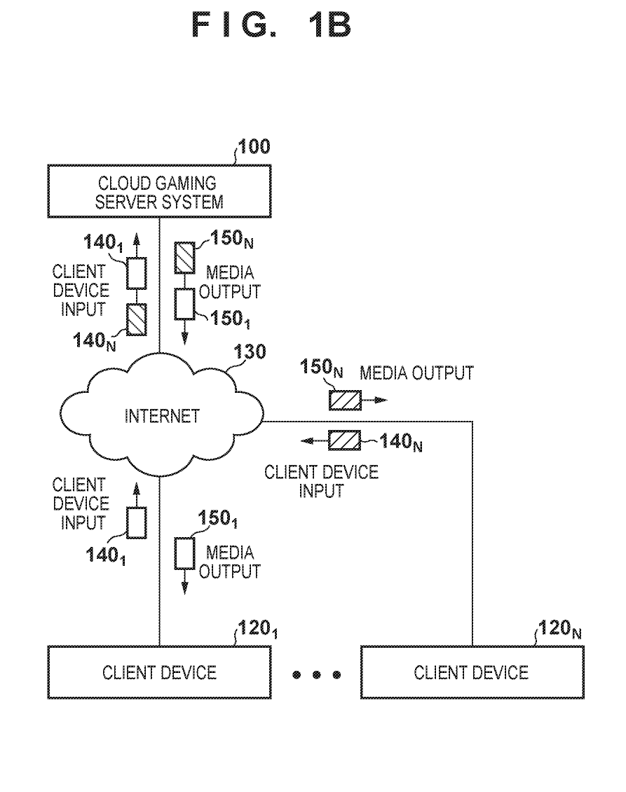

FIG. 1A schematically shows a cloud-based system architecture according to a non-limiting embodiment of the present invention. The architecture may include client devices 120ₙ (where 1≦n≦N and where N represents the number of users participating in the video game) connected to an information processing apparatus, such as a server system 100, over a data network such as the Internet 130. It should be appreciated that N, the number of client devices in the cloud-based system architecture, is not particularly limited.

The server system 100 provides a virtual space in which a plurality of client device users can simultaneously participate. In some cases, this virtual space may represent a video game, while in other cases it may provide a visual effect that is used as a tool for supporting communication or improving user experiences for communication. Each user can operate and move within the space a corresponding avatar which is positioned in the virtual space. When a user operates an avatar in the virtual space, a screen for a viewpoint set in the space is provided to the client device of the user. The viewpoint may be selected from among preset fixed viewpoints, or may be selectively changeable by the user, or be something that is changed in accordance with movement (rotation) operation on the avatar by the user.

The configuration of the client devices 120ₙ (1≦n≦N) is not particularly limited. In some embodiments, one or more of the client devices 120 (1≦n≦N) may be embodied in a personal computer (PC), a home game machine (console), a portable game machine, a smart television, a set-top box (STB), etc. In other embodiments, one or more of the client devices 120ₙ (1≦n≦N) may be a communication or computing device such as a mobile phone, a personal digital assistant (PDA), or a tablet.

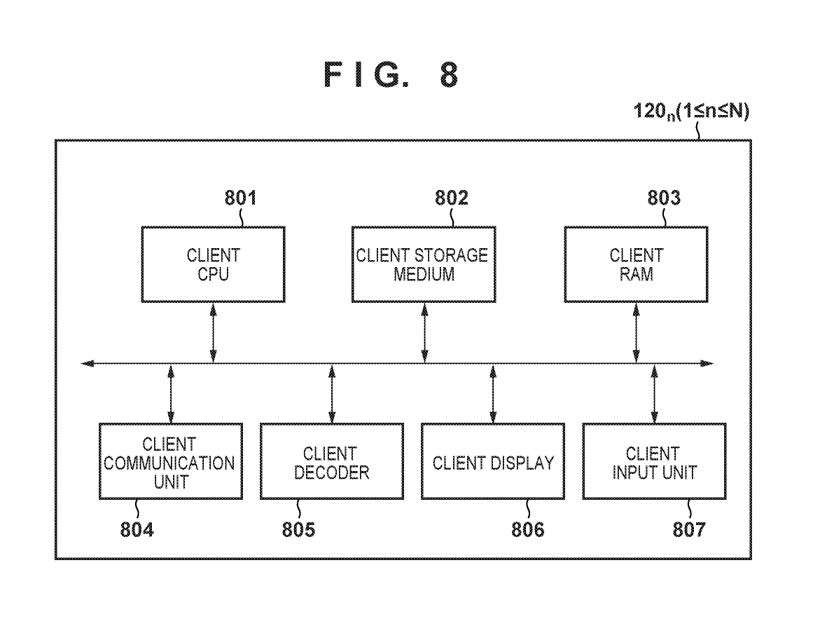

FIG. 8 shows a general configuration of an example client device 120ₙ (1≦n≦N) in accordance with a non-limiting embodiment of the present invention. A client CPU 801 may control operation of blocks/modules comprised in the client device 120ₙ. The client CPU 801 may control operation of the blocks by reading out operation programs for the blocks stored in a client storage medium 802, loading them into a client RAM 803 and executing them. The client storage medium 802 may be an HDD, a non-volatile ROM, or the like. Also, operation programs may be dedicated applications, browsing applications or the like. In addition to being a program loading area, the client RAM 803 may also be used as a storage area for temporarily storing such things as intermediate data output in the operation of any of the blocks.

A client communication unit 804 may be a communication interface comprised in the client device 120ₙ. In an embodiment, the client communication unit 804 may receive encoded screen data of the provided service from the information processing apparatus (server system 100) via the Internet 130. Also, in the reverse direction of communication, the client communication unit 804 may transmit information regarding operation inputs made by the user of the client device 120ₙ via the Internet 130 to the information processing apparatus (server system 100). A client decoder 805 may decode encoded screen data received by the client communication unit 804 and generate screen data. The generated screen data is presented to the user of the client device 120ₙ by being output to a client display 806 and displayed. Note that it is not necessary that the client device have the client display 806, and the client display 806 may be an external display apparatus connected to the client device.

A client input unit 807 may be a user interface comprised in the client device 120ₙ. The client input unit 807 may include input devices (such as a touch screen, a keyboard, a game controller, a joystick, etc.), and detect operation input by the user. For the detected operation input, integrated data may be transmitted via the client communication unit 804 to the server system 100, and may be transmitted as information indicating that a particular operation input was performed after analyzing the operation content. Also, the client input unit 807 may include other sensors (e.g., Kinect™) that may include a camera or the like, that detect as operation input a motion of a particular object, or a body motion made by the user. In addition, the client device 120ₙ may include a loudspeaker for outputting audio.

Returning now to FIG. 1A, each of the client devices 120ₙ (1≦n≦N) may connect to the Internet 130 in any suitable manner, including over a respective local access network (not shown). The server system 100 may also connect to the Internet 130 over a local access network (not shown), although the server system 100 may connect directly to the Internet 130 without the intermediary of a local access network. Connections between the cloud gaming server system 100 and one or more of the client devices 120ₙ (1≦n≦N) may comprise one or more channels. These channels can be made up of physical and/or logical links, and may travel over a variety of physical media, including radio frequency, fiber optic, free-space optical, coaxial and twisted pair. The channels may abide by a protocol such as UDP or TCP/IP. Also, one or more of the channels may be supported a virtual private network (VPN). In some embodiments, one or more of the connections may be session-based.

The server system 100 may enable users of the client devices 120ₙ (1≦n≦N) to play video games, either individually (i.e., a single-player video game) or in groups (i.e., a multi-player video game). The server system 100 may also enable users of the client devices 120ₙ (1≦n≦N) to spectate games (join as a spectator in games) being played by other players. Non-limiting examples of video games may include games that are played for leisure, education and/or sport. A video game may but need not offer users the possibility of monetary gain.

The server system 100 may also enable users of the client devices 120ₙ (1≦n≦N) to test video games and/or administer the server system 100.

The server system 100 may include one or more computing resources, possibly including one or more game servers, and may comprise or have access to one or more databases, possibly including a user (participant) database 10. The user database 10 may store account information about various users and client devices 120ₙ (1≦n≦N), such as identification data, financial data, location data, demographic data, connection data and the like. The game server(s) may be embodied in common hardware or they may be different servers that are connected via a communication link, including possibly over the Internet 130. Similarly, the database(s) may be embodied within the server system 100 or they may be connected thereto via a communication link, possibly over the Internet 130.

The server system 100 may implement an administrative application for handling interaction with client devices 120ₙ (1≦n≦N) outside the game environment, such as prior to game play. For example, the administrative application may be configured for registering a user of one of the client devices 120ₙ (1≦n≦N) in a user class (such as a “player”, “spectator”, “administrator” or “tester”), tracking the user's connectivity over the Internet, and responding to the user's command(s) to launch, join, exit or terminate an instance of a game, among several non-limiting functions. To this end, the administrative application may need to access the user database 10.

The administrative application may interact differently with users in different user classes, which may include “player”, “spectator”, “administrator” and “tester”, to name a few non-limiting possibilities. Thus, for example, the administrative application may interface with a player (i.e., a user in the “player” user class) to allow the player to set up an account in the user database 10 and select a video game to play. Pursuant to this selection, the administrative application may invoke a server-side video game application. The server-side video game application may be defined by computer-readable instructions that execute a set of modules for the player, allowing the player to control a character, avatar, race car, cockpit, etc. within a virtual world of a video game. In the case of a multi-player video game, the virtual world may be shared by two or more players, and one player's game play may affect that of another. In another example, the administrative application may interface with a spectator (i.e., a user in the “spectator” user class) to allow the spectator to set up an account in the user database 10 and select a video game from a list of ongoing video games that the user may wish to spectate. Pursuant to this selection, the administrative application may invoke a set of modules for that spectator, allowing the spectator to observe game play of other users but not to control active characters in the game. (Unless otherwise indicated, where the term “user” is employed, it is meant to apply equally to both the “player” user class and the “spectator” user class.)

In a further example, the administrative application may interface with an administrator (i.e., a user in the “administrator” user class) to allow the administrator to change various features of the game server application, perform updates and manage player/spectator accounts.

In yet another example, the game server application may interface with a tester (i.e., a user in the “tester” user class) to allow the tester to select a video game to test. Pursuant to this selection, the game server application may invoke a set of modules for the tester, allowing the tester to test the video game.

FIG. 1B illustrates interaction that may take place between client devices 120ₙ (1≦n≦N) and the server system 100 during game play, for users in the “player” or “spectator” user class.

In some non-limiting embodiments, the server-side video game application may cooperate with a client-side video game application, which can be defined by a set of computer-readable instructions executing on a client device, such as client device 120 (1≦n≦N). Use of a client-side video game application may provide a customized interface for the user to play or spectate the game and access game features. In other non-limiting embodiments, the client device does not feature a client-side video game application that is directly executable by the client device. Rather, a web browser may be used as the interface from the client device's perspective. The web browser may itself instantiate a client-side video game application within its own software environment so as to optimize interaction with the server-side video game application.

The client-side video game application running (either independently or within a browser) on the given client device may translate received user inputs and detected user movements into “client device input”, which may be sent to the cloud gaming server system 100 over the Internet 130.

In the illustrated embodiment of FIG. 1B, client devices 120ₙ (1≦n≦N) may produce client device input 140ₙ (1≦n≦N), respectively. The server system 100 may process the client device input 140ₙ (1≦n≦N) received from the various client devices 120ₙ (1≦n≦N) and may generate respective “media output” 150, (1≦n≦N) for the various client devices 120ₙ (1≦n≦N). The media output 150, (1≦n≦N) may include a stream of encoded video data (representing images when displayed on a screen) and audio data (representing sound when played via a loudspeaker). The media output 150, (1≦n≦N) may be sent over the Internet 130 in the form of packets. Packets destined for a particular one of the client devices 120ₙ (1≦n≦N) may be addressed in such a way as to be routed to that device over the Internet 130. Each of the client devices 120ₙ (1≦n≦N) may include circuitry for buffering and processing the media output in the packets received from the cloud gaming server system 100, as well as a display for displaying images and a transducer (e.g., a loudspeaker) for outputting audio. Additional output devices may also be provided, such as an electro-mechanical system to induce motion.

It should be appreciated that a stream of video data can be divided into “frames”. The term “frame” as used herein does not require the existence of a one-to-one correspondence between frames of video data and images represented by the video data. That is to say, while it is possible for a frame of video data to contain data representing a respective displayed image in its entirety, it is also possible for a frame of video data to contain data representing only part of an image, and for the image to in fact require two or more frames in order to be properly reconstructed and displayed. By the same token, a frame of video data may contain data representing more than one complete image, such that N images may be represented using M frames of video data, where M<N.

### II. Cloud Gaming Server System 100 (Distributed Architecture)

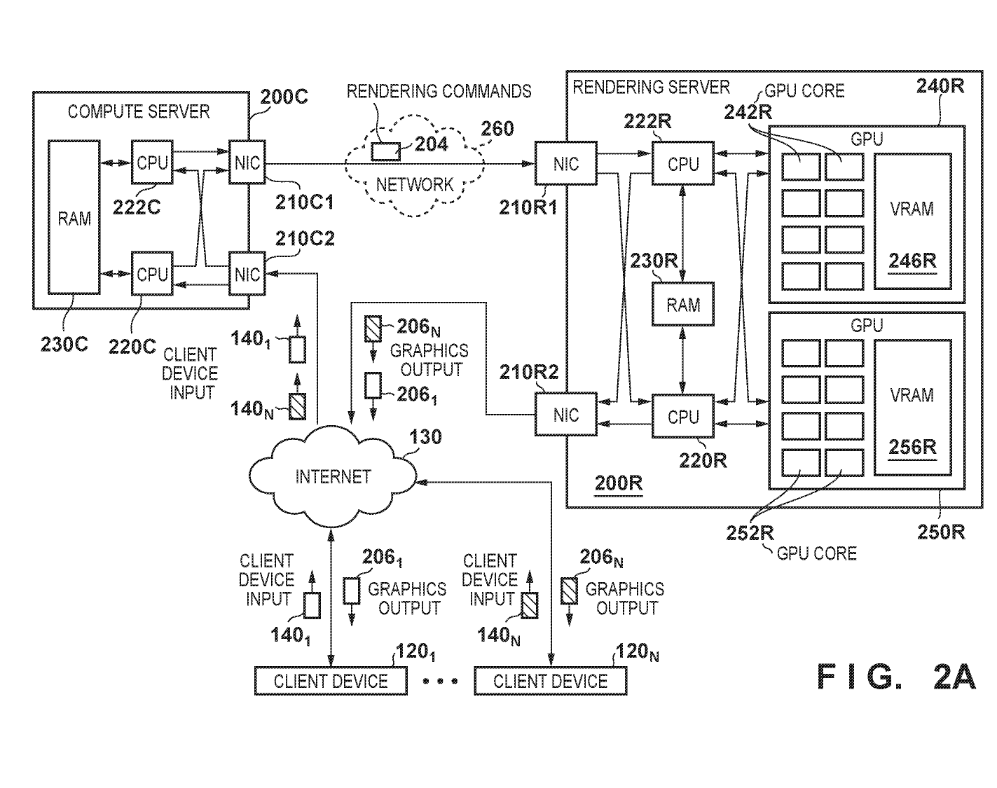

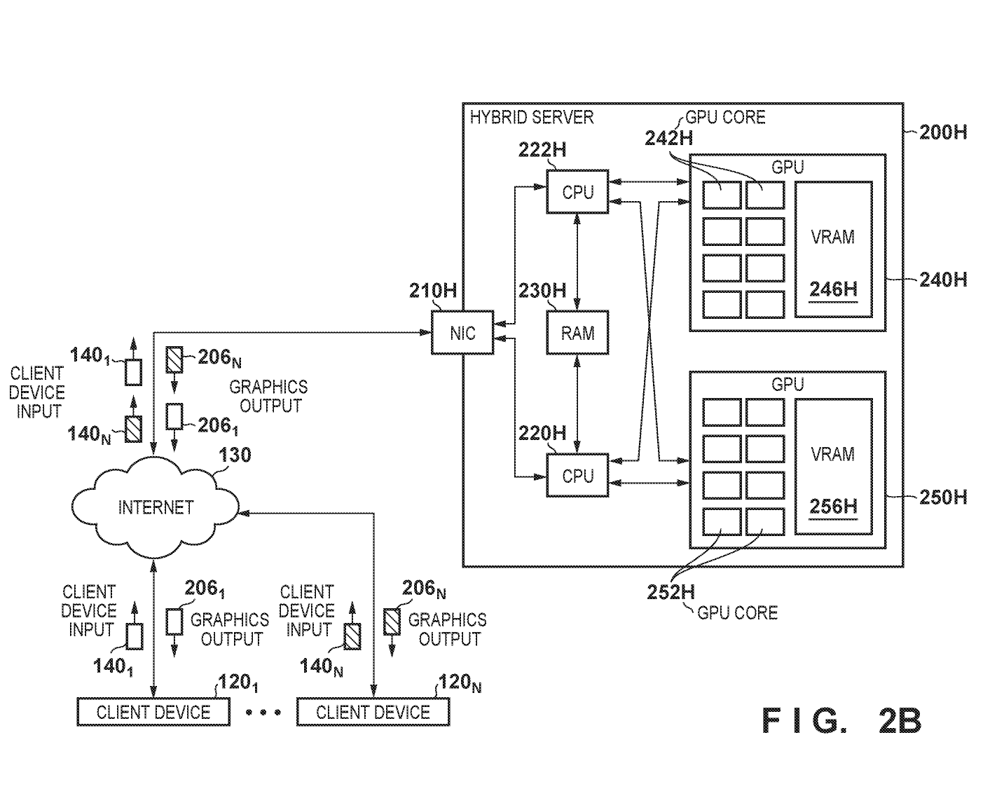

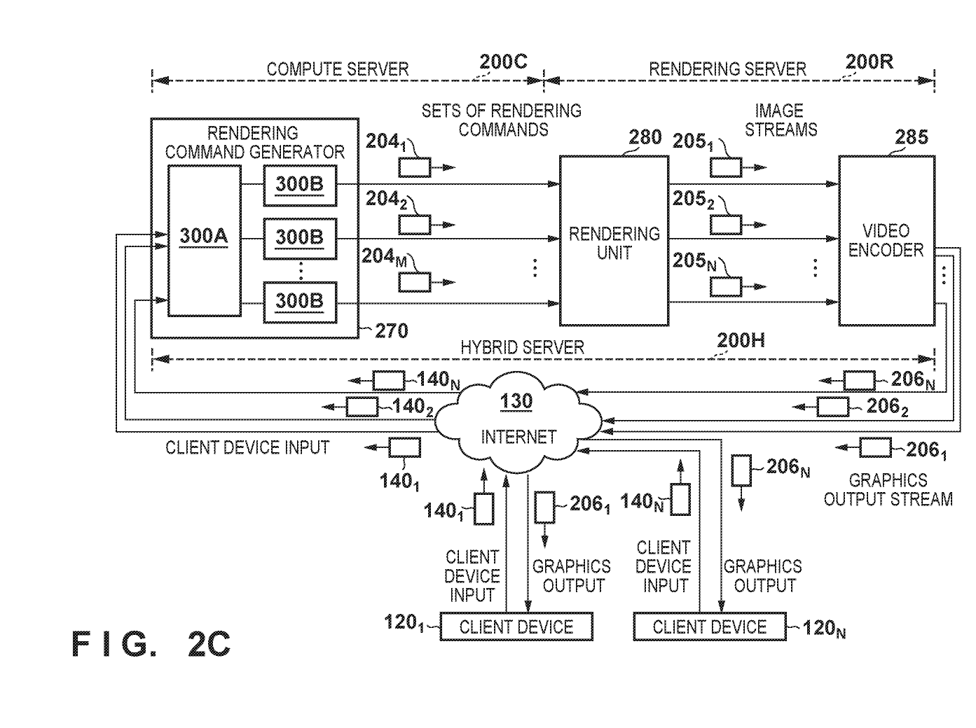

FIG. 2A shows one possible non-limiting physical arrangement of components for the cloud gaming server system 100. In this embodiment, individual servers within the cloud gaming server system 100 may be configured to carry out specialized functions. For example, a compute server 200C may be primarily responsible for tracking state changes in a video game based on user input, while a rendering server 200R may be primarily responsible for rendering graphics (video data).

The users of client devices 120ₙ (1≦n≦N) may be players or spectators. It should be understood that in some cases there may be a single player and no spectator, while in other cases there may be multiple players and a single spectator, in still other cases there may be a single player and multiple spectators and in yet other cases there may be multiple players and multiple spectators.

For the sake of simplicity, the following description refers to a single compute server 200C connected to a single rendering server 200R. However, it should be appreciated that there may be more than one rendering server 200R connected to the same compute server 200C, or more than one compute server 200C connected to the same rendering server 200R. In the case where there are multiple rendering servers 200R, these may be distributed over any suitable geographic area.

As shown in the non-limiting physical arrangement of components in FIG. 2A, the compute server 200C may comprise one or more central processing units (CPUs) 220C, 222C and a random access memory (RAM) 230C. The CPUs 220C, 222C can have access to the RAM 230C over a communication bus architecture, for example. While only two CPUs 220C, 222C are shown, it should be appreciated that a greater number of CPUs, or only a single CPU, may be provided in some example implementations of the compute server 200C. The compute server 200C may also comprise a receiver for receiving client device input over the Internet 130 from each of the client devices participating in the video game. In the presently described example embodiment, client devices 120ₙ (1≦n≦N) are assumed to be participating in the video game, and therefore the received client device input may include client device input 140n (1≦n≦N). In a non-limiting embodiment, the receiver may be implemented by a network interface component (NIC) 210C2.

The compute server 200C may further comprise transmitter for outputting sets of rendering commands 204ₘ, where 1≦m≦M. In a non-limiting embodiment, M represents the number of users (or client devices), but this need not be the case in every embodiment, particularly where a single set of rendering commands is shared among multiple users. Thus, M simply represents the number of generated sets of rendering commands. The sets of rendering commands 204ₘ (1≦m≦M) output from the compute server 200C may be sent to the rendering server 200R. In a non-limiting embodiment, the transmitter may be embodied by a network interface component (NIC) 210C1. In one embodiment, the compute server 200C may be connected directly to the rendering server 200R. In another embodiment, the compute server 200C may be connected to the rendering server 200R over a network 260, which may be the Internet 130 or another network. A virtual private network (VPN) may be established between the compute server 200C and the rendering server 200R over the network 260.

At the rendering server 200R, the sets of rendering commands 204ₘ (1≦m≦M) sent by the compute server 200C may be received at a receiver (which may be implemented by a network interface component (NIC) 210R1) and may be directed to one or more CPUs 220R, 222R. The CPUs 220R, 222R may be connected to graphics processing units (GPUs) 240R, 250R. By way of non-limiting example, GPU 240R may include a set of GPU cores 242R and a video random access memory (VRAM) 246R. Similarly, GPU 250R may include a set of GPU cores 252R and a video random access memory (VRAM) 256R. Each of the CPUs 220R, 222R may be connected to each of the GPUs 240R, 250R or to a subset of the GPUs 240R, 250R. Communication between the CPUs 220R, 222R and the GPUs 240R, 250R can be established using, for example, a communication bus architecture. Although only two CPUs and two GPUs are shown, there may be more than two CPUs and GPUs, or even just a single CPU or GPU, in a specific example of implementation of the rendering server 200R.

The CPUs 220R, 222R may cooperate with the GPUs 240R, 250R to convert the sets of rendering commands 204ₘ (1≦m≦M) into graphics output streams 206ₙ, where 1≦n≦N and where N represents the number of users (or client devices) participating in the video game. Specifically, there may be N graphics output streams 206ₙ (1≦n≦N) for the client devices 120ₙ (1≦n≦N), respectively. This will be described in further detail later on. The rendering server 200R may comprise a further transmitter (which may be implemented by a network interface component (NIC) 210R2), through which the graphics output streams 206ₙ (1≦n≦N) may be sent to the client devices 120ₙ (1≦n≦N), respectively.

### III. Cloud Gaming Server System 100 (Hybrid Architecture)

FIG. 2B shows a second possible non-limiting physical arrangement of components for the cloud gaming server system 100. In this embodiment, a hybrid server 200H may be responsible both for tracking state changes in a video game based on user input, and for rendering graphics (video data).

As shown in the non-limiting physical arrangement of components in FIG. 2B, the hybrid server 200H may comprise one or more central processing units (CPUs) 220H, 222H and a random access memory (RAM) 230H. The CPUs 220H, 222H may have access to the RAM 230H over a communication bus architecture, for example. While only two CPUs 220H, 222H are shown, it should be appreciated that a greater number of CPUs, or only a single CPU, may be provided in some example implementations of the hybrid server 200H. The hybrid server 200H may also comprise a receiver for receiving client device input is received over the Internet 130 from each of the client devices participating in the video game. In the presently described example embodiment, client devices 120ₙ (1≦n≦N) are assumed to be participating in the video game, and therefore the received client device input may include client device input 140ₙ (1≦n≦N). In a non-limiting embodiment, the receiver may be implemented by a network interface component (NIC) 210H.

In addition, the CPUs 220H, 222H may be connected to a graphics processing units (GPUs) 240H, 250H. By way of non-limiting example, GPU 240H may include a set of GPU cores 242H and a video random access memory (VRAM) 246H. Similarly, GPU 250H may include a set of GPU cores 252H and a video random access memory (VRAM) 256H. Each of the CPUs 220H, 222H may be connected to each of the GPUs 240H, 250H or to a subset of the GPUs 240H, 250H. Communication between the CPUs 220H, 222H and the GPUs 240H, 250H may be established using, for example, a communications bus architecture. Although only two CPUs and two GPUs are shown, there may be more than two CPUs and GPUs, or even just a single CPU or GPU, in a specific example of implementation of the hybrid server 200H.

The CPUs 220H, 222H may cooperate with the GPUs 240H, 250H to convert the sets of rendering commands 204ₘ (1≦m≦M) into graphics output streams 206ₙ (1≦n≦N). Specifically, there may be N graphics output streams 206ₙ (1≦n≦N) for the participating client devices 120ₙ (1≦n≦N), respectively. The graphics output streams 206ₙ (1≦n≦N) may be sent to the client devices 120ₙ (1≦n≦N), respectively, via a transmitter which, in a non-limiting embodiment, may be implemented at least in part by the NIC 210H.

### IV. Cloud Gaming Server System 100 (Functionality Overview)

During game play, the server system 100 runs a server-side video game application, which can be composed of a set of modules. With reference to FIG. 2C, these modules may include a rendering command generator 270, a rendering unit 280 and a video encoder 285. These modules may be implemented by the above-described physical components of the compute server 200C and the rendering server 200R (in FIG. 2A) and/or of the hybrid server 200H (in FIG. 2B). For example, according to the non-limiting embodiment of FIG. 2A, the rendering command generator 270 may be implemented by the compute server 200C, while the rendering unit 280 and the video encoder 285 may be implemented by the rendering server 200R. According to the non-limiting embodiment of FIG. 2B, the hybrid server 200H may implement the rendering command generator 270, the rendering unit 280 and the video encoder 285.

The present example embodiment discusses a single rendering command generator 270 for simplicity of illustration. However, it should be noted that in an actual implementation of the cloud gaming server system 100, many rendering command generators similar to the rendering command generator 270 may be executed in parallel. Thus, the cloud gaming server system 100 may support multiple independent instantiations of the same video game, or multiple different video games, simultaneously. Also, it should be noted that the video games can be single-player video games or multi-player games of any type.

The rendering command generator 270 may be implemented by certain physical components of the compute server 200C (in FIG. 2A) or of the hybrid server 200H (in FIG. 2B). Specifically, the rendering command generator 270 may be encoded as computer-readable instructions that are executable by a CPU (such as the CPUs 220C, 222C in the compute server 200C or the CPUs 220H, 222H in the hybrid server 200H). The instructions can be tangibly stored in the RAM 230C (in the compute server 200C) of the RAM 230H (in the hybrid server 200H) or in another memory area, together with constants, variables and/or other data used by the rendering command generator 270. In some embodiments, the rendering command generator 270 may be executed within the environment of a virtual machine that may be supported by an operating system that is also being executed by a CPU (such as the CPUs 220C, 222C in the compute server 200C or the CPUs 220H, 222H in the hybrid server 200H).

The rendering unit 280 may be implemented by certain physical components of the rendering server 200R (in FIG. 2A) or of the hybrid server 200H (in FIG. 2B). In an embodiment, the rendering unit 280 may take up one or more GPUs (240R, 250R in FIG. 2A, 240H, 250H in FIG. 2B) and may or may not utilize CPU resources.

The video encoder 285 may be implemented by certain physical components of the rendering server 200R (in FIG. 2A) or of the hybrid server 200H (in FIG. 2B). Those skilled in the art will appreciate that there are various ways in which to implement the video encoder 285. In the embodiment of FIG. 2A, the video encoder 285 may be implemented by the CPUs 220R, 222R and/or by the GPUs 240R, 250R. In the embodiment of FIG. 2B, the video encoder 285 may be implemented by the CPUs 220H, 222H and/or by the GPUs 240H, 250H. In yet another embodiment, the video encoder 285 may be implemented by a separate encoder chip (not shown).

In operation, the rendering command generator 270 may produce the sets of rendering commands 204ₘ (1≦m≦M), based on received client device input 140ₙ (1≦n≦N). The received client device input may carry data (e.g., an address) identifying the rendering command generator 270 for which it is destined, and/or possibly data identifying the user and/or client device from which it originates.

Rendering commands refer to commands which may be used to instruct a specialized graphics processing unit (GPU) to produce a frame of video data or a sequence of frames of video data. Referring to FIG. 2C, the sets of rendering commands 204ₘ (1≦m≦M) result in the production of frames of video data by the rendering unit 280. The images represented by these frames may change as a function of responses to the client device input 140ₙ, (1≦n≦N) that are programmed into the rendering command generator 270. For example, the rendering command generator 270 may be programmed in such a way as to respond to certain specific stimuli to provide the user with an experience of progression (with future interaction being made different, more challenging or more exciting), while the response to certain other specific stimuli will provide the user with an experience of regression or termination. Although the instructions for the rendering command generator 270 may be fixed in the form of a binary executable file, the client device input 140 (1≦n≦N) is unknown until the moment of interaction with a player who uses the corresponding client device 120 (1≦n≦N). As a result, there can be a wide variety of possible outcomes, depending on the specific client device input that is provided. This interaction between players/spectators and the rendering command generator 270 via the client devices 120 (1≦n≦N) can be referred to as “game play” or “playing a video game”.

The rendering unit 280 may process the sets of rendering commands 204ₘ (1≦m≦M) to create multiple video data streams 205 (1≦n≦N, where N refers to the number of users/client devices participating in the video game). Thus, there may generally be one video data stream created per user (or, equivalently, per client device). When performing rendering, data for one or more objects represented in three-dimensional space (e.g., physical objects) or two-dimensional space (e.g., text) may be loaded into a cache memory (not shown) of a particular GPU 240R, 250R, 240H, 250H. This data may be transformed by the GPU 240R, 250R, 240H, 250H into data representative of a two-dimensional image, which may be stored in the appropriate VRAM 246R, 256R, 246H, 256H. As such, the VRAM 246R, 256R, 246H, 256H may provide temporary storage of picture element (pixel) values for a game screen.

The video encoder 285 may compress and encodes the video data in each of the video data streams 205ₙ, (1≦n≦N) into a corresponding stream of compressed/encoded video data. The resultant streams of compressed/encoded video data, referred to as graphics output streams, may be produced on a per-client-device basis. In the present example embodiment, the video encoder 285 may produce graphics output streams 206ₙ (1≦n≦N) for client devices 120ₙ (1≦n≦N), respectively. Additional modules may be provided for formatting the video data into packets so that they can be transmitted over the Internet 130. The video data in the video data streams 205ₙ (1≦n≦N) and the compressed/encoded video data within a given graphics output stream may be divided into frames.

### V. Generation of Rendering Commands

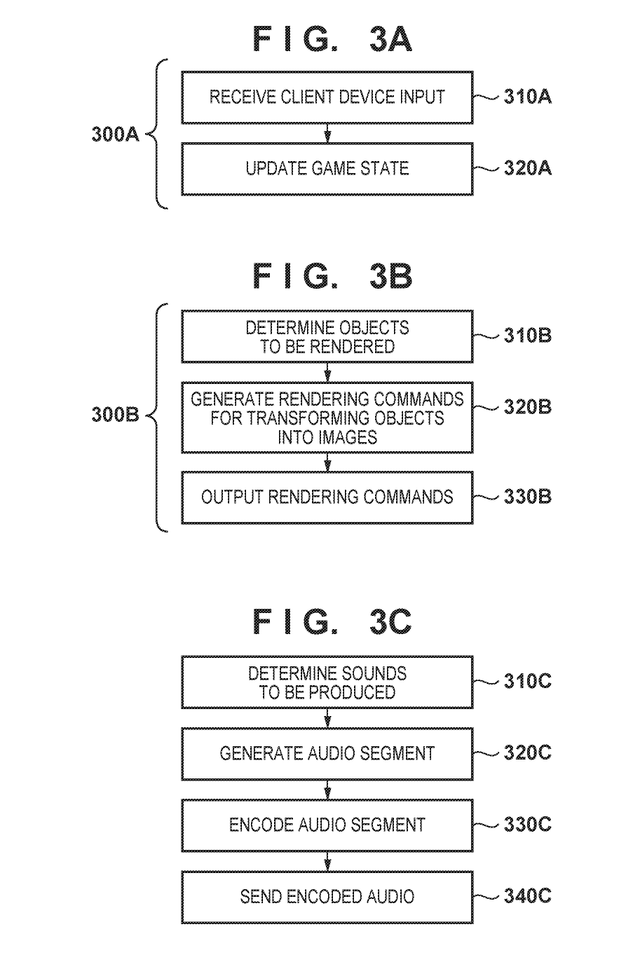

Generation of rendering commands by the rendering command generator 270 is now described in greater detail with reference to FIGS. 2C, 3A and 3B. Specifically, execution of the rendering command generator 270 may involve several processes, including a main game process 300A and a graphics control process 300B, which are described herein below in greater detail.

Main Game Process

The main game process 300A is described with reference to FIG. 3A. The main game process 300A may execute repeatedly as a continuous loop. As part of the main game process 300A, there may be provided an action 310A, during which client device input may be received. If the video game is a single-player video game without the possibility of spectating, then client device input (e.g., client device input 140₁) from a single client device (e.g., client device 120₁) is received as part of action 310A. If the video game is a multi-player video game or is a single-player video game with the possibility of spectating, then the client device input from one or more client devices may be received as part of action 310A.

By way of non-limiting example, the input from a given client device may convey that the user of the given client device wishes to cause a character under his or her control to move, jump, kick, turn, swing, pull, grab, etc. Alternatively or in addition, the input from the given client device may convey a menu selection made by the user of the given client device in order to change one or more audio, video or gameplay settings, to load/save a game or to create or join a network session. Alternatively or in addition, the input from the given client device may convey that the user of the given client device wishes to select a particular camera view (e.g., first-person or third-person) or reposition his or her viewpoint within the virtual world.

At action 320A, the game state may be updated based at least in part on the client device input received at action 310A and other parameters. Updating the game state may involve the following actions:

Firstly, updating the game state may involve updating certain properties of the user (player or spectator) associated with the client devices from which the client device input may have been received. These properties may be stored in the user database 10. Examples of user properties that may be maintained in the user database 10 and updated at action 320A can include a camera view selection (e.g., 1^{st} person, 3^{rd} person), a mode of play, a selected audio or video setting, a skill level, a customer grade (e.g., guest, premium, etc.).

Secondly, updating the game state may involve updating the attributes of certain objects in the virtual world based on an interpretation of the client device input. The objects whose attributes are to be updated may in some cases be represented by two- or three-dimensional models and may include playing characters, non-playing characters and other objects. In the case of a playing character, attributes that can be updated may include the object's position, strength, weapons/armor, lifetime left, special powers, speed/direction (velocity), animation, visual effects, energy, ammunition, etc. In the case of other objects (such as background, vegetation, buildings, vehicles, score board, etc.), attributes that can be updated may include the object's position, velocity, animation, damage/health, visual effects, textual content, etc.

It should be appreciated that parameters other than client device input may influence the above properties (of users) and attributes (of virtual world objects). For example, various timers (such as elapsed time, time since a particular event, virtual time of day, total number of players, a user's geographic location, etc.) can have an effect on various aspects of the game state.

Once the game state has been updated further to execution of action 320A, the main game process 300A may return to action 310A, whereupon new client device input received since the last pass through the main game process is gathered and processed.

Graphics Control Process

A second process, referred to as the graphics control process, is now described with reference to FIG. 3B. Although shown as separate from the main game process 300A, the graphics control process 300B may execute as an extension of the main game process 300A. The graphics control process 300B may execute continually resulting in generation of the sets of rendering commands 204ₘ (1≦m≦M). In the case of a single-player video game without the possibility of spectating, there is only one user (i.e., N=1) and therefore only one resulting set of rendering commands 204₁ (i.e., M=1) to be generated. In other cases, N (the number of users) is greater than 1. For example, in the case of a multi-player video game, multiple distinct sets of rendering commands (M>1) need to be generated for the multiple players, and therefore multiple sub-processes may execute in parallel, one for each player. On the other hand, in the case of a single-player game with the possibility of spectating (again, multiple users and therefore N>1), there may be only a single set of rendering commands 204₁ (M=1), with the resulting video data stream being duplicated for the spectators by the rendering unit 280. Of course, these are only examples of implementation and are not to be taken as limiting.

Consider operation of the graphics control process 300B for a given user requiring one of the video data streams 205ₙ (1≦n≦N). At action 310B, the rendering command generator 270 may determine the objects to be rendered for the given user. This action may include identifying the following types of objects: Firstly, this action may include identifying those objects from the virtual world that are in the “game screen rendering range” (also known as a “scene”) for the given user. The game screen rendering range may include a portion of the virtual world that would be “visible” from the perspective of the given user's camera. This may depend on the position and orientation of that camera relative to the objects in the virtual world. In a non-limiting example of implementation of action 310B, a frustum may be applied to the virtual world, and the objects within that frustum are retained or marked. The frustum has an apex which may be situated at the location of the given user's camera and may have a directionality also defined by the directionality of that camera.

Secondly, this action can include identifying additional objects that do not appear in the virtual world, but which nevertheless may need to be rendered for the given user. For example, these additional objects may include textual messages, graphical warnings and dashboard indicators, to name a few non-limiting possibilities.

At action 320B, the rendering command generator 270 may generate a set of commands 204ₘ (1≦m≦M) for rendering into graphics (video data) the objects that were identified at action 310B. Rendering may refer to the transformation of 3-D or 2-D coordinates of an object or group of objects into data representative of a displayable image, in accordance with the viewing perspective and prevailing lighting conditions. This may be achieved using any number of different algorithms and techniques, for example as described in “Computer Graphics and Geometric Modelling: Implementation & Algorithms”, Max K. Agoston, Springer-Verlag London Limited, 2005, hereby incorporated by reference herein. The rendering commands may have a format that in conformance with a 3D application programming interface (API) such as, without limitation, “Direct3D” from Microsoft Corporation, Redmond, Wash., and “OpenGL” managed by Khronos Group, Beaverton, Oreg.

At action 330B, the rendering commands generated at action 320B may be output to the rendering unit 280. This may involve packetizing the generated rendering commands into a set of rendering commands 204ₘ (1≦m≦M) that is sent to the rendering unit 280.

### VI. Generation of Graphics Output

The rendering unit 280 may interpret the sets of rendering commands 204ₘ (1≦m≦M) and produce multiple video data streams 205ₙ (1≦n≦N), one for each of the N participating client devices 120ₙ (1≦n≦N). Rendering may be achieved by the GPUs 240R, 250R, 240H, 250H under control of the CPUs 220R, 222R (in FIG. 2A) or 220H, 222H (in FIG. 2B). The rate at which frames of video data are produced for a participating client device may be referred to as the frame rate.

In an embodiment where there are N users, the N video data streams 205ₙ (1≦n≦N) may be created from respective sets of rendering commands 204ₘ (1≦m≦M, where M=N). In that case, rendering functionality is not shared among the users. However, the N video data streams 205ₙ (1≦n≦N) may also be created from M sets of rendering commands 204ₘ) (1≦m≦M, where M is less than N), such that fewer sets of rendering commands need to be processed by the rendering unit 280. In that case, the rendering unit 280 may perform sharing or duplication in order to generate a larger number of video data streams 205ₙ (1≦n≦N) from a smaller number of sets of rendering commands 204ₘ (1≦m≦M, where M<N). Such sharing or duplication may be prevalent when multiple users (e.g., spectators) desire to view the same camera perspective. Thus, the rendering unit 280 may perform functions such as duplicating a created video data stream for one or more spectators.

Next, the video data in each of the video data streams 205ₙ (1≦n≦N) may be encoded by the video encoder 285, resulting in a sequence of encoded video data associated with each client device, referred to as a graphics output stream. In the example embodiments of FIGS. 2A-2C, the sequence of encoded video data destined for each of the client devices 120ₙ (1≦n≦N) is referred to as graphics output stream 206ₙ (1≦n≦N).

The video encoder 285 may be a device (or set of computer-readable instructions) that enables or carries out or defines a video compression or decompression algorithm for digital video. Video compression may transform an original stream of digital image data (expressed in terms of pixel locations, color values, etc.) into an output stream of digital image data that conveys substantially the same information but using fewer bits. Any suitable compression algorithm may be used. In addition to data compression, the encoding process used to encode a particular frame of video data may or may not involve cryptographic encryption.

The graphics output streams 206ₙ (1≦n≦N) created in the above manner may be sent over the Internet 130 to the respective client devices. By way of non-limiting example, the graphics output streams may be segmented and formatted into packets, each having a header and a payload. The header of a packet containing video data for a given user may include a network address of the client device associated with the given user, while the payload may include the video data, in whole or in part. In a non-limiting embodiment, the identity and/or version of the compression algorithm used to encode certain video data may be encoded in the content of one or more packets that convey that video data. Other methods of transmitting the encoded video data may occur to those of skill in the art.

While the present description focuses on the rendering of video data representative of individual 2-D images, the present invention does not exclude the possibility of rendering video data representative of multiple 2-D images per frame to create a 3-D effect.

### VII. Game Screen Reproduction at Client Device

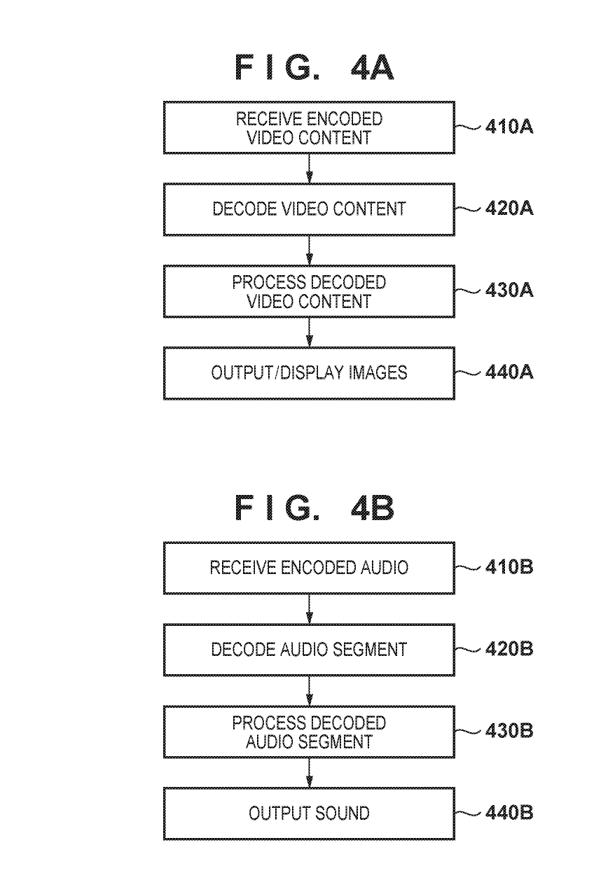

Reference is now made to FIG. 4A, which shows operation of a client-side video game application that may be executed by the client device associated with a given user, which may be any of the client devices 120ₙ (1≦n≦N), by way of non-limiting example. In operation, the client-side video game application may be executable directly by the client device or it may run within a web browser, to name a few non-limiting possibilities.

At action 410A, a graphics output stream (from among the graphics output streams 206ₙ (1≦n≦N)) may be received over the Internet 130 from the rendering server 200R (FIG. 2A) or from the hybrid server 200H (FIG. 2B), depending on the embodiment. The received graphics output stream may comprise compressed/encoded of video data which may be divided into frames.

At action 420A, the compressed/encoded frames of video data may be decoded/decompressed in accordance with the decompression algorithm that is complementary to the encoding/compression algorithm used in the encoding/compression process. In a non-limiting embodiment, the identity or version of the encoding/compression algorithm used to encode/compress the video data may be known in advance. In other embodiments, the identity or version of the encoding/compression algorithm used to encode the video data may accompany the video data itself.

At action 430A, the (decoded/decompressed) frames of video data may be processed. This can include placing the decoded/decompressed frames of video data in a buffer, performing error correction, reordering and/or combining the data in multiple successive frames, alpha blending, interpolating portions of missing data, and so on. The result may be video data representative of a final image to be presented to the user on a per-frame basis.

At action 440A, the final image may be output via the output mechanism of the client device. For example, a composite video frame may be displayed on the display of the client device.

### VIII. Audio Generation

A third process, referred to as the audio generation process, is now described with reference to FIG. 3C. The audio generation process may execute continually for each user requiring a distinct audio stream. In one embodiment, the audio generation process may execute independently of the graphics control process 300B. In another embodiment, execution of the audio generation process and the graphics control process may be coordinated.

At action 310C, the rendering command generator 270 may determine the sounds to be produced. Specifically, this action may include identifying those sounds associated with objects in the virtual world that dominate the acoustic landscape, due to their volume (loudness) and/or proximity to the user within the virtual world.

At action 320C, the rendering command generator 270 may generate an audio segment. The duration of the audio segment may span the duration of a video frame, although in some embodiments, audio segments may be generated less frequently than video frames, while in other embodiments, audio segments may be generated more frequently than video frames.

At action 330C, the audio segment may be encoded, e.g., by an audio encoder, resulting in an encoded audio segment. The audio encoder can be a device (or set of instructions) that enables or carries out or defines an audio compression or decompression algorithm. Audio compression may transform an original stream of digital audio (expressed as a sound wave changing in amplitude and phase over time) into an output stream of digital audio data that conveys substantially the same information but using fewer bits. Any suitable compression algorithm may be used. In addition to audio compression, the encoding process used to encode a particular audio segment may or may not apply cryptographic encryption.

It should be appreciated that in some embodiments, the audio segments may be generated by specialized hardware (e.g., a sound card) in either the compute server 200C (FIG. 2A) or the hybrid server 200H (FIG. 2B). In an alternative embodiment that may be applicable to the distributed arrangement of FIG. 2A, the audio segment may be parameterized into speech parameters (e.g., LPC parameters) by the rendering command generator 270, and the speech parameters can be redistributed to the destination client device by the rendering server 200R.

The encoded audio created in the above manner is sent over the Internet 130. By way of non-limiting example, the encoded audio input may be broken down and formatted into packets, each having a header and a payload. The header may carry an address of a client device associated with the user for whom the audio generation process is being executed, while the payload may include the encoded audio. In a non-limiting embodiment, the identity and/or version of the compression algorithm used to encode a given audio segment may be encoded in the content of one or more packets that convey the given segment. Other methods of transmitting the encoded audio may occur to those of skill in the art.

Reference is now made to FIG. 4B, which shows operation of the client device associated with a given user, which may be any of client devices 120ₙ (1≦n≦N), by way of non-limiting example.

At action 410B, an encoded audio segment may be received from the compute server 200C, the rendering server 200R or the hybrid server 200H (depending on the embodiment). At action 420B, the encoded audio may be decoded in accordance with the decompression algorithm that is complementary to the compression algorithm used in the encoding process. In a non-limiting embodiment, the identity or version of the compression algorithm used to encode the audio segment may be specified in the content of one or more packets that convey the audio segment.

At action 430B, the (decoded) audio segments may be processed. This may include placing the decoded audio segments in a buffer, performing error correction, combining multiple successive waveforms, and so on. The result may be a final sound to be presented to the user on a per-frame basis.

At action 440B, the final generated sound may be output via the output mechanism of the client device. For example, the sound may be played through a sound card or loudspeaker of the client device.

### IX. Specific Description of Non-Limiting Embodiments

A more detailed description of certain non-limiting embodiments of the present invention is now provided.

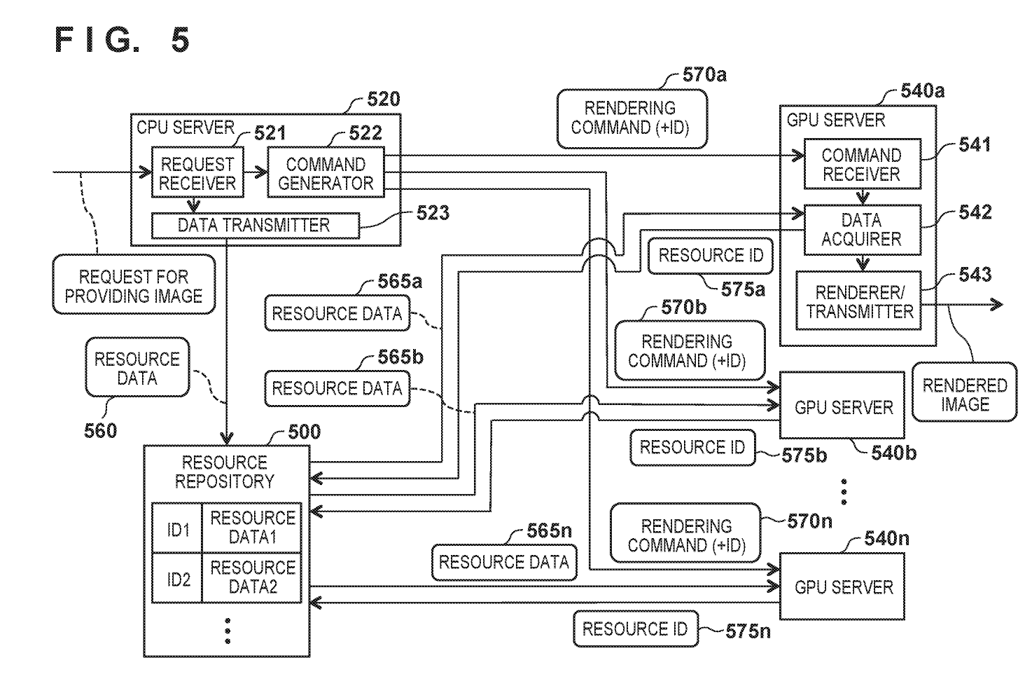

FIG. 5 illustrates an exemplary configuration of an image rendering system of the non-limiting embodiments. In the non-limiting embodiments, as illustrated in FIG. 5, a Resource Repository 500 for storing resource data used for rendering processing in a GPU server(s) 540 (e.g., rendering server 200R) is provided as a separate entity different to a CPU server 520 (e.g., a compute server 200C, or a central server of a system) and the GPU server(s) 540. Note that there may be only one GPU server in the system, although the system can comprise multiple GPU servers. The Resource Repository 500 may be provided in a server, which comprises CPUs (e.g., CPUs 220H and 222H) and GPUs (e.g., GPU 240R and 250R). Hereinafter, a case where there exist multiple GPU servers 540 and the CPU server 520 is a separate entity from the GPU servers 540 will be described.

In the non-limiting embodiments, upon a request receiver 521 in the CPU server 520 receiving a request for provision of an image 550, a data transmitter 523 in the CPU server 520 transmits resource data 560 to the Resource Repository 500 only. That is, the CPU server 520 does not transmit the resource data 560 to the GPU server 540. A command generator 522 generates a rendering command 570 which includes identification information identifying the resource data 560 in the Resource Repository 500, and transmits the rendering command 570 to the GPU server 540. In the GPU server 540, when a command receiver 541 receives the rendering command 570, a data acquirer 542 takes the resource data 565 from the Resource Repository 500, by e.g., transmitting identification information of the resource data 565 (resource ID) included in the rendering command 570 to the Resource Repository 500. A render/transmitter 543 in the GPU server 540 then executes rendering processing and renders an image corresponding to the request for provision of an image sent by the client device 120 and transmits the rendered image to the client device 120. Details of those servers will be described below.

The CPU server 520 may receive a request for provision of an image from the client device 120, extract resource data according to the request and then transmit the extracted resource data to the Resource Repository 500. The request for provision of an image may relate to a request for provision of a screen of a game content. The client device 120 may transmit the request periodically or upon receiving user's operation for controlling, e.g., a character in a game. The extraction of the resource data may include acquiring the resource data in the middle of processing for execution of a game in the CPU server 520. The CPU server 520 may not transmit resource data in a case where the same resource data was transmitted to and is not removed from the Resource Repository 500. In this case, information on resource data, which is currently stored in the Resource Repository 500, may be shared by the CPU server 520 and the Resource Repository 500. In some cases, the information may be also shared by the CPU server 520, the GPU servers 540 and the Resource Repository 500. In some embodiments, the information may be generated in the form of a table that indicates which of the resource data transmitted from the CPU server 520 is stored in the Resource Repository 500. For example, the Resource Repository 500 generates the table and transmits it to the CPU server 520 and in some cases to the GPU servers 540. In other cases, the CPU server 520 may manage resource data which was transmitted from the CPU server 520 to the Resource Repository 500 and which was then removed from the Resource Repository 500. In this case, the CPU server 520 manages a list of resource data and adds certain resource data to the list in a case where the CPU server 520 transmits the certain resource data to the Resource Repository 500. On the other hand, the Resource Repository 500 reports, to the CPU server 520, resource data which was removed from the Resource Repository 500. The CPU server 520 then deletes the reported resource data from the managed list. The CPU server 520 may transmit the managed list to the GPU server 540 and/or the Resource Repository 500. The CPU server 520 then transmits rendering commands 570, which include information on the resource data, to at least one of the GPU servers 540. The CPU server 520 is able to identify resource data 560 transmitted to the Resource Repository 500 by allocating identifier information (ID) for the resource data 560, and therefore to configure rendering commands 570 to be transmitted to the GPU servers 540, using simple identifier information. Note, the identifier information may be allocated by the CPU server 520 before being transmitted, or may be allocated and be reported to the CPU server 520 by a processor of the Resource Repository 500. In addition, the identifier information may be different from information directly specifying data location, for example on a memory of the Resource Repository 500. That is, since the location may be change, the identifier information just indicates one content (resource data) regardless of its location. Alternatively, in a case, for example, where the data location of the resource data is permanently or semi-permanently defined (e.g., the data location is not changed until the resource data is removed from the Resource Repository 500), the identifier information may indicate the location on which the resource data is stored on the memory of the Resource Repository 500.

The Resource Repository 500 is configured to be accessible from a plurality of GPU servers 540, and in a case where a GPU server 540 receives a rendering command 570 including identifier information from the CPU server 520 and resource data corresponding to the identifier information is not stored in (or loaded into) a local cache memory of the GPU server 540, the GPU server 540 acquires the necessary resource data from the Resource Repository 500 based on the identifier information 575 included in the rendering command, and performs rendering processing. That is, each of the GPU servers 540 receives a rendering command 570 (or a set of rendering commands) including identifier information, checks whether or not resource data corresponding to the identifier information is loaded into a memory of the GPU server 540, acquires, and loads into a memory, the resource data 565 corresponding to the identifier information by sending the identifier information 575 to the Resource Repository 500 in a case where the resource data corresponding to the identifier information is not held by the GPU server 540, and renders an image using the acquired and loaded resource data 565. The GPU server 540 then outputs the rendered image (a screen image for the client device 120), and the image is encoded and transmitted to the client device 120. The encoding and transmission of the rendered image may be performed in the GPU server 540 or in another entity.

By configuring the system in this way, usage of communication bandwidth due to the resource data being sent from the CPU server 520 is reduced because multiple transmissions of identical resource data from the CPU server 520 to the Resource Repository 500 is not necessary and transmission of identical resource data to the same or to separate GPU servers 540 is reduced. In addition, reduction of the data amount for rendering commands and re-usage of resource data between multiple GPU servers 540 can be realized. Moreover, usage of communication bandwidth due to acquisition of resource data by the GPU servers 540 can be reduced because the GPU servers 540 acquires the resource data only in a case where the resource data is not held in the GPU servers 540 themselves.

In some embodiments, the CPU server 520 can select one of the GPU servers 540 for provision of the game screens to the client device 120 based on the progress and conditions of the game. Alternatively, another server, which manages GPU servers 540, may receive requests from the CPU server 520, and perform selection of GPU servers 540. For example, the CPU server 520 (or the other server having received the requests from the CPU server 520) performs allocation of GPU servers 540 so that a common GPU server generates the game screens for client devices 120 for which the progress or the situation of the game is similar such as when the progress of the game is at the same level or a field in the game in which the user's operation character exists is the same. This is because the possibility is great that common resource data is used for the generation of game screens provided to client devices 120 for which the progress or the situation of the game is similar. In other words, the possibility is great that re-usable resource data is already stored in a local cache memory which is accessible at higher speed for a GPU server 540 for which this kind of allocation is performed. Alternatively, the CPU server 520 (or the other server having received the requests from the CPU server 520) can perform allocation of GPU servers 540 so that, in a case where common resource data is used in rendering processing of a plurality of screen images for a plurality of client devices 120, a common GPU server 540 renders the plurality of screen images based on the common resource data.

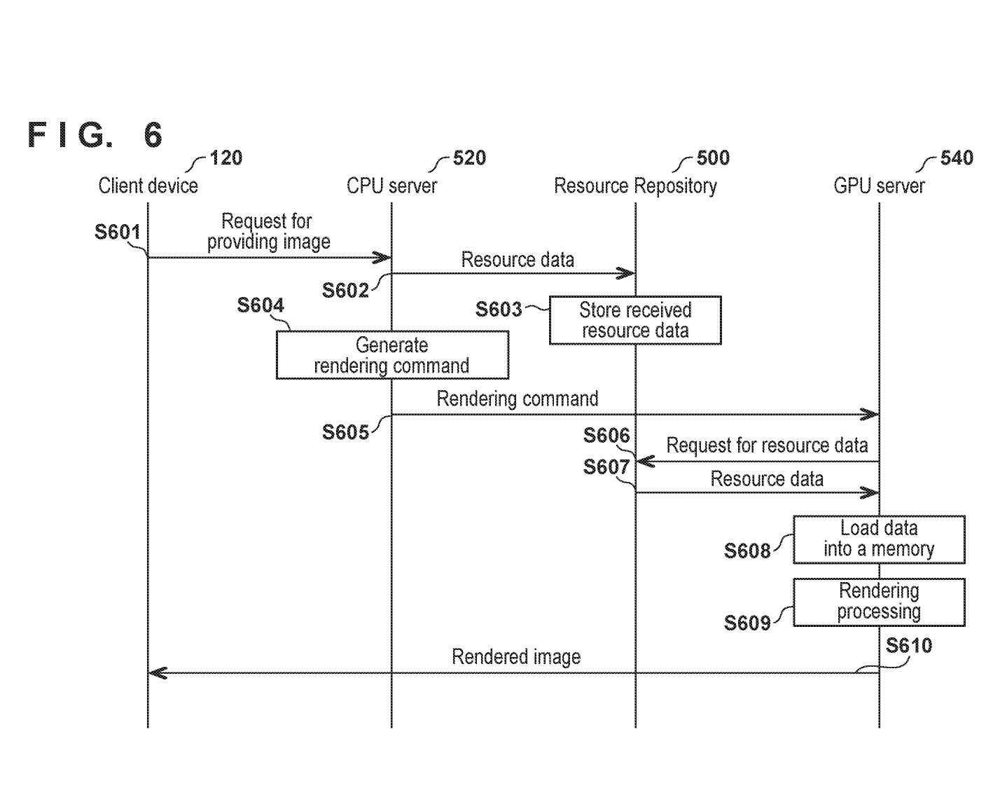

FIG. 6 is a sequence diagram of an exemplary process executed in the rendering system described above. In the process, the client device 120 transmits a request for provision of an image to the CPU server 520 (step S601). The CPU server 520 then transmits, based on the request, resource data necessary for rendering processing corresponding to the received request (step S602), and the Resource Repository 500 stores the transmitted resource data in association with identification information identifying the resource data (step S603). The identification information may be generated by the CPU server 520 or may be generated and reported to the CPU server 520 by the Resource Repository 500. The CPU server 520 then generates a rendering command (or a set of rendering commands) which includes the identification information (step S604) and transmits the rendering command to the GPU server 540 (step S605). The GPU server 540 receives the rendering command (step S605), and then acquires the resource data identified by the identification information included in the received rendering commands from the Resource Repository 500. For example, the GPU server transmits a request for the resource data including the identification information (step S606) and acquires the resource data corresponding to the identification information (step S607). The GPU server 540 then loads the resource data into a memory of the GPU server 540 (step S608). The GPU server 540 then executes, based on the received rendering command, rendering processing using the resource data acquired and loaded into the memory and renders an image corresponding to the request for provision of an image from the client device (step S609). Finally, the GPU server transmits the rendered image to the client device (step S610).

Accordingly, an access frequency at which the GPU server 540 accesses the Resource Repository 500 can be reduced, and processing time required for generation of game screens can be reduced. Also, even if, hypothetically, the required resource data does not exist in the cache memory, because the GPU server 540 can acquire the resource data from the Resource Repository 500, provision of game screens to the client device 120 can be performed without obstacle even in a case where the client device 120 is allocated to a separate GPU server 540 in accordance with the progress of the game.

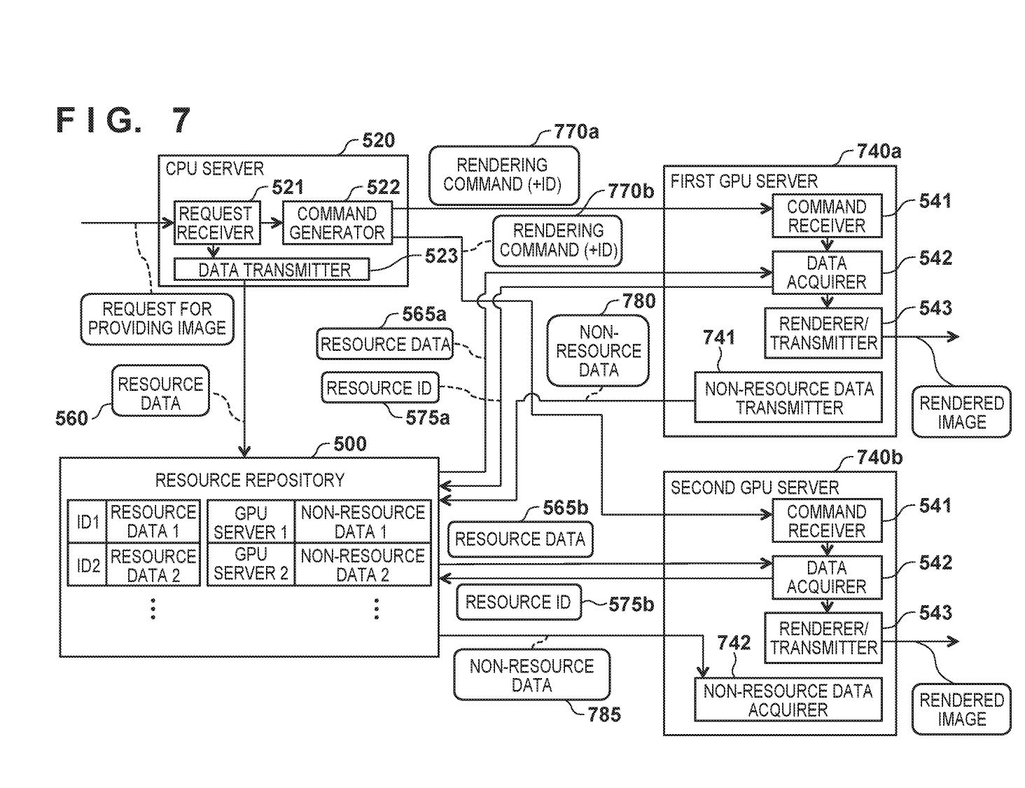

In other embodiments, as shown in FIG. 7, a non-resource data transmitter 741 in a first GPU server 740a can transmit data 780, which is obtained in the first GPU server 740a and used for at least one of the rendering process or transmission of the screen, to the Resource Repository 500. Note, the transmitted data (hereinafter referred to as the “non-resource data”) 780 is different from the resource data 565, which is transmitted from CPU server 520 to the Resource Repository 500. That is, the non-resource data 780 may be data, which is different from the resource data 565, but is necessary to render an image and/or transmit it to a client device 120 that transmitted a request for provision of an image to the CPU server 520. Accordingly, the non-resource data 780 may include data generated by the first GPU server 740a. Additionally or alternatively, the non-resource data may be dynamically-varying data while the resource data may be static data. The dynamically-varying data may be “simulation” that is not calculated from scratch every frame, but using results from previous frames, for example in physics, particles or animation fields. There are also a lot of algorithms that are called “temporal” which means that they need multiple frames of data to be able to get a result. The data that the algorithms use may also be considered as dynamically-varying data. In a case where the GPU server 740a renders an image using one or more previously-rendered images, the non-resource data may include the previously-rendered images. By this configuration, a non-resource data acquirer 742 in a second GPU server 740b, which is different from the first GPU server 740a, can then acquire the non-resource data 785 by accessing to the Resource Repository 500, and, instead of the first GPU server 740a, render an image and transmit it to a client device 120 that transmitted a request for provision of an image to the CPU server 520.

The switching of the GPU server for rendering an image for a client device 120 may be performed in a case where the first GPU server 740a, which is currently rendering the image for the client device 120, is in an overloaded state. For example, it is determined that the first GPU server 740a may be in an overloaded state in a case where a value of at least one of a usage rate of a central processing unit (CPU), a usage rate of a graphics processing unit (GPU), a usage rate of a memory in the CPU, a usage rate of a memory in the GPU, a usage rate of a hard disk drive, a band usage rate of a network, a power usage rate, or a heat generation level in the first GPU server 740a is larger than a predetermined value. The determination whether or not the first GPU server 740a is in an overloaded state may be performed by the CPU server 520, the first GPU server 740a, the second GPU server 740b or another entity.

In a case where the CPU server 520 performs the determination, the CPU server 520 may switch destination of the rendering commands from the first GPU server 740a to the second GPU server 740b and start transmission of the rendering command 770b to the second GPU server 740b in a case where the CPU server 520 determines that the first GPU server 740a is in an overloaded state. In this case, the CPU server 520 may include additional information indicating that the switching of the GPU servers is performed into the rendering command 770b. Alternatively, the CPU server 520 may transmit another signal to the second GPU server 740b to report that the first GPU server 740a is in an overloaded state.

The second GPU server 740b may recognize that the first GPU server 740a is in an overloaded state by receiving the rendering command 770b or the above-described signal from the CPU server 520. In this case, the second GPU server 740b may acquire the resource data 565b and the non-resource data 785 from the Resource Repository 500 upon receiving the rendering command 770b transmitted from the CPU server 520 or transferred from the first GPU server 740a, render an image and transmit it to a client device 120 that transmitted a request for provision of an image to the CPU server 520, based on the acquired resource data and non-resource data. Alternatively, the second GPU server 740b may periodically, that is, in a hot-standby manner, acquire the non-resource data 785, and acquire the resource data 565b upon receiving the rendering command 770b. The second GPU server 740b may periodically acquire the resource data 770b and the non-resource data 785, and start rendering and transmission of an image according to the rendering command 770b. The second GPU server 740b may acquire the non-resource data 785 after acquiring receives the resource data 565b from the Resource Repository 500 based on the rendering command 770b and loading the resource data 565b into a memory.

In a case where the first GPU server 740a performs the determination, the first GPU server 740a may notify the second GPU server 740b that the first GPU server 740a is in an overloaded state, in a case where the first GPU server 740a determines that the first GPU server 740a itself is in an overloaded state. The second GPU server 740b may recognize that the first GPU server 740a is in an overloaded state by receiving the notification from the first GPU server 740a. In this case, the second GPU server 740b may acquire the resource data 565b and the non-resource data 785 from the Resource Repository 500 upon receiving the rendering command 770b transmitted from the CPU server 520 or transferred from the first GPU server 740a, render an image and transmit it to a client device 120 that transmitted a request for provision of an image to the CPU server 520, based on the acquired resource data and non-resource data. Alternatively, the second GPU server 740b may periodically acquire the non-resource data 785, and acquire the resource data 565b upon receiving the rendering command 770b. The second GPU server 740b may periodically acquire the resource data 770b and the non-resource data 785, and start rendering and transmission of an image according to the rendering command 770b. The second GPU server 740b may acquire the non-resource data 785 after acquiring receives the resource data 565b from the Resource Repository 500 based on the rendering command 770b and loading the resource data 565b into a memory.

In a case where the second GPU server 740b performs the determination, the second GPU server 740b can recognize that the first GPU server 740a is in an overloaded state by the determination. Accordingly, the second GPU server 740b may acquire the resource data 565b and the non-resource data 785 from the Resource Repository 500. Then, according to the rendering command 770b transmitted from the CPU server 520 or transferred from the first GPU server 740a, the second GPU server 740b can render an image and transmit it to a client device 120 that transmitted a request for provision of an image to the CPU server 520, based on the acquired resource data and non-resource data. The second GPU server 740b may report the CPU server 520 that the first GPU server 740a is in an overloaded state, and cause the CPU server 520 to start transmission of the rendering command 770b to the second GPU server 740b. Note, the second GPU server 740b may periodically acquire the non-resource data 785, acquire the resource data 565b upon receiving the rendering command 770b and start rendering and transmission of an image according to the rendering command 770b. The second GPU server 740b may periodically acquire the resource data 770b and the non-resource data 785, and start rendering and transmission of an image according to the rendering command 770b. By periodically acquiring the non-resource data, the second GPU server 740b can be synchronized with the first GPU server 740a, and therefore transparent switching of a rendering server from the first GPU server 740a to the second GPU server 740b can be achieved. In a case where, for example, a certain level of popping or stuttering on a screen is acceptable, the second GPU server 740b may acquire the non-resource data 785 after acquiring receives the resource data 565b from the Resource Repository 500 based on the rendering command and loading the resource data 565b into a memory.

In a case where another entity performs the determination, the entity notifies the CPU server 520, the first GPU server 740a and/or the second GPU server 740b that the first GPU server is in an overloaded state, and one of the above-described processing is performed according to which server the notification is made to.

The switching of the GPU server for rendering an image for a client device 120 may be performed in a case where at least a part of the first rendering server fails. Detection of the failure may be performed by receiving a signal periodically transmitted from the first GPU server 740a. For example, the first GPU server 740a periodically transmits a notification signal indicative of an operating state of the first GPU server 740a, and the CPU server 520 or the second GPU server 740b recognize the operating state of the first GPU server 740a (e.g., whether or not the failure occurs in the first GPU server 740a). The CPU server 520 or the second GPU server 740b may recognize that the failure occurs in the first GPU server 740a in a case where the notification signal is not received for a predetermined time period or in a case where the notification signal indicates that the first GPU server 740a does not operate normally. The predetermined time period may be set longer than a time period of the notification signal transmission. Alternatively, the CPU server 520, the second GPU server 740b, or another entity may perform the detection by monitoring whether or not the first GPU server 740a operates normally. In a case where another entity performs the detection, the entity notifies the CPU server 520, the first GPU server 740a and/or the second GPU server 740b of the detection result.

After detecting the failure, processing similar to that described above in relation to the case whether the first GPU server 740 is in an overloaded state may be performed. For example, in a case where the CPU server 520 performs the detection, the CPU server 520 may switch destination of the rendering commands from the first GPU server 740a to the second GPU server 740b and start transmission of the rendering command 770b to the second GPU server 740b in a case where the CPU server 520 detects that the failure occurs in the first GPU server 740a. In this case, the CPU server 520 may include additional information indicating that the switching of the GPU servers is performed into the rendering command 770b. Alternatively, the CPU server 520 may transmit another signal to the second GPU server 740b to report that the failure occurs in the first GPU server 740a.

According to the above described configuration, in a case where one of the GPU servers is in an overloaded state or in a case where failures occur in one of the GPU servers, it is easy for the CPU server 520 to transfer the users, which have received game screens from the GPU server, to another GPU server of the GPU servers. That is, since the GPU server, to which the users are transferred, can acquire the resource data and the non-resource data from the Resource Repository 500, the CPU server 520 has no need to change rendering commands except for their destinations.

Note, all or a part of the elements of each above-described embodiment may be implemented by one or more software programs. That is, all or a part of the above-described features may be performed when the one or more software programs are executed in one or more computers comprised in the CPU server, the GPU servers, or the Resource Repository. Of course, all or a part of the elements of each above-described embodiment may be implemented by one or more hardware components.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Also, the rendering system and the control method according to the present invention are realizable by a program executing the methods on a computer. The program is providable/distributable by being stored on a computer-readable storage medium or through an electronic communication line.

This application claims the benefit of U.S. Provisional Patent Application No. 61/920,835 filed Dec. 26, 2013, which is hereby incorporated by reference herein in its entirety.

1. A rendering system comprising a central server which causes one of a plurality of rendering servers connected to the central server to execute rendering processing for a screen corresponding to a screen providing request sent from a client device, and a repository device which stores necessary resource data for the rendering processing and which the plurality of rendering servers are able to access,
wherein the central server comprises:
a request receiving unit configured to receive the screen providing requests from client devices;
a resource transmitting unit configured to transmit, based on the screen providing request received by the request receiving unit, necessary resource data for rendering processing corresponding to the screen providing request to the repository device; and
a command transmitting unit configured to generate rendering commands which include identification information identifying the necessary resource data stored in the repository device and transmit the commands to one of the plurality of rendering servers,
wherein the repository device comprises storage unit configured to store the necessary resource data transmitted by the resource transmitting unit in association with the identification information, and
wherein the rendering server comprises:
a command receiving unit configured to receive rendering commands from the central server;
a loading unit configured to receive, from the repository device, the necessary resource data identified by the identification information included in the received rendering commands and load the data into a memory;
a rendering unit configured to execute, based on the received rendering commands, rendering processing using the necessary resource data loaded in the memory and render a screen corresponding to the screen providing request; and
a screen transmitting unit configured to transmit the rendered screen to a client device, which transmitted the screen providing request.

2. The rendering system according to claim 1, wherein, in a case where the whole of the necessary resource data, which are identified by the identification information including the rendering commands, have not been loaded into the memory yet, the loading unit receives the remaining portion of the necessary resource data from the repository device.

3. The rendering system according to claim 1, wherein the screen providing request is a request for provision of a screen of a game content, and
wherein the command transmitting unit transmits the rendering commands corresponding to the screen providing request received from client devices, for which the progress or the situation of the game is similar, to the same rendering server among the plurality of rendering servers.

4. The rendering system according to claim 1, wherein the command transmitting unit transmits rendering commands, for which common necessary resource data is used in the rendering processing, to the same rendering server among the plurality of rendering servers.

5. The rendering system according to claim 1 wherein a first rendering server of the plurality of rendering servers comprises a data transmitting unit configured to transmit data, which is obtained in the first rendering server and used for at least one of the rendering process or transmission of the screen, to the repository device, the transmitted data being different from the necessary resource data; and
wherein a second rendering server of the plurality of rendering servers comprises a data acquisition unit configured to acquire the data different from the necessary resource data, which was transmitted to the repository device by the first rendering server.

6. The rendering system according to claim 5, wherein the data different from the necessary resource data includes data having been generated by the first rendering server.

7. The rendering system according to claim 5, wherein the necessary resource data is static data and the data different from the necessary resource data includes dynamically-varying data.

8. The rendering system according to claim 5, wherein the second rendering server acquires the data different from the necessary resource data in a case where the first rendering server is in an overloaded state.

9. The rendering system according to claim 8, wherein the second rendering server further comprising a determination unit configured to monitor a value of at least one of a usage rate of a central processing unit, a usage rate of a graphics processing unit, a usage rate of a memory in a central processing unit, a usage rate of a memory in a graphics processing unit, a usage rate of a hard disk drive, a band usage rate of a network, a power usage rate, or a heat generation level in the first rendering server, and determine that the first rendering server is in an overloaded state in a case where the value is larger than a predetermined value.

10. The rendering system according to claim 8, wherein the first rendering server further comprising a
determination unit configured to determine that the first rendering server is in an overloaded state in a case where a value of at least one of a usage rate of a central processing unit, a usage rate of a graphics processing unit, a usage rate of a memory in a central processing unit, a usage rate of a memory in a graphics processing unit, a usage rate of a hard disk drive, a band usage rate of a network, a power usage rate, or a heat generation level in the first rendering server, is larger than a predetermined value, and
a notifying unit configured to notify the second rendering server that the first rendering server is in an overloaded state in a case where it is determined that the first rendering server is in an overloaded state.

11. The rendering system according to claim 5, wherein the second rendering server acquires the data different from the necessary resource data in a case where at least a part of the first rendering server fails.

12. The rendering system according to claim 11, wherein the second rendering server further comprises a monitoring unit configured to monitor whether or not the first rendering server is operating normally.

13. The rendering system according to claim 11, wherein the first rendering server further comprises a notifying unit configured to periodically transmit a notification signal indicative of an operating state of the first rendering server to the second rendering server; and
wherein the second rendering server comprising a determination unit configured to determine that at least a part of the first rendering server fails in a case where the notification signal is not received for a predetermined period or in a case where the notification signal indicates that the first rendering server does not operate normally.

14. The rendering system according to claim 5, wherein the second rendering server periodically acquires the data different from the necessary resource data.

15. The rendering system according to claim 5, wherein the second rendering server acquires the data different from the necessary resource data after the second rendering server acquires the identification information from the central server or the first rendering server, receives the necessary resource data identified by the identification information from the repository device and loads the necessary resource data into a memory.

16. A control method of a rendering system comprising a central server which causes one of a plurality of rendering servers connected to the central server to execute rendering processing for a screen corresponding to a screen providing request sent from a client device, and a repository device which stores necessary resource data for the rendering processing and which the plurality of rendering servers are able to access, the method comprising the steps of:
the central server receiving the screen providing requests from client devices;
the central server transmitting, based on the received screen providing request, necessary resource data for rendering processing corresponding to the screen providing request to the repository device;
the repository device storing the necessary resource data transmitted by the central server in association with identification information identifying the necessary resource data,
the central server generating rendering commands which include the identification information and transmitting the commands to one of the plurality of rendering servers,
the rendering server receiving rendering commands from the central server;
the rendering server receiving, from the repository device, the necessary resource data identified by the identification information included in the received rendering commands and loading the data into a memory;
the rendering server executing, based on the received rendering commands, rendering processing using the necessary resource data loaded in the memory and rendering a screen corresponding to the screen providing request; and
the rendering server transmitting the rendered screen to a client device, which transmitted the screen providing request.

17. A non-transitory computer-readable storage medium storing a program for causing one or more computers to function as at least one unit of a rendering system defined in claim 1.
